(19) United States
(12) Patent Application Publication
(10) Pub. No.: US 2021/0201370 A1
(43) Pub. Date: Jul. 1, 2021

(54) NON-LINEAR DYNAMIC PRICING FOR TOLLING SYSTEMS

(71) Applicant: ELECTRONIC TRANSACTION CONSULTANTS CORP., Richardson, TX (US)

(72) Inventor: Alessandro Stagni, Richardson, TX (US)

(21) Appl. No.: 16/731,878

(22) Filed: Dec. 31, 2019

(51) Int. Cl. G06Q 30/02; G01C 21/34

(52) U.S. Cl. CPC G06Q 30/0283; G06Q 2240/00; G01C 21/3492

(57) ABSTRACT

A method includes receiving sensor data from a sensor system associated with a roadway, the sensor data comprising information for speed and timing of vehicles passing within a managed lane of the roadway. The method further includes determining, based on the sensor data a current level-of-service for the managed lane. The method further includes comparing the current level-of-service for the managed lane with a target level-of-service for the managed lane. The method further includes calculating a price adjustment for the managed lane based on a difference between the current level-of-service and the target level-of-service, the price adjustment having a non-linear relationship between the price adjustment and the difference.

### BACKGROUND

Many roadways use a tolling system in which several lanes are general-purpose lanes and one or more lanes are managed lanes. Managed lanes typically charge customers a specific amount for using the lane as a mechanism to manage traffic within that lane. Using a static specific amount may work well as a general basis but does not have the flexibility to manage various traffic conditions at different times of the day, different times of the year, or with various road conditions. Accordingly, there is a need to manage lanes in a more flexible and customer-friendly manner.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram showing an illustrative environment with general-purpose lanes and a managed lane in which non-linear dynamic pricing may be used, according to one example of principles described herein.

FIG. 2 is a flowchart showing an illustrative method for non-linear dynamic pricing for tolling systems, according to one example of principles described herein.

FIG. 3A is a diagram showing an illustrative graph showing a non-linear relationship between price adjustment and rate-of-change for a positive level-of-service differential, according to one example of principles described herein.

FIG. 3B is a diagram showing an illustrative graph showing a non-linear relationship between price adjustment and rate-of-change for a negative level-of-service differential, according to one example of principles described herein.

FIG. 4 is a diagram showing illustrative level-of-service bands, according to one example of principles described herein.

FIG. 5 is a diagram showing absolute price over time with various level-of-service bands, according to one example of principles described herein.

FIG. 6 is a diagram showing an illustrative computing system for performing non-linear dynamic pricing for tolling systems, according to one example of principles described herein.

FIG. 7 is a flowchart showing an illustrative method for non-linear dynamic pricing for tolling systems, according to one example of principles described herein.

### DESCRIPTION

The following disclosure provides many different embodiments, or examples, for implementing different features of the invention. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

As described above, many roadways use a tolling system in which several lanes are general-purpose lanes and one or more lanes are managed lanes. Managed lanes typically charge customers a specific amount for using the lane as a mechanism to manage traffic within that lane. Using a static specific amount may work well as a general basis but does not have the flexibility to manage various traffic conditions at different times of the day, different times of the year, or with various road conditions. Accordingly, there is a need to manage lanes in a more flexible and customer-friendly manner.

Currently in the tolling industry, technology does not allow a tollway operator much control of the management of traffic within a particular lane. Nor does current technology work with a customized definition of level-of-service. Rather, current technology is characterized by calculations rigidly based on transit volumes and speed. When doing so, there can be undesirable oscillation effects. For example, if the managed lane becomes packed and traffic slows, the price may be increased so that customers may decide to leave the managed lane and thus free it up for other customers who are willing to pay the higher price. Conversely, if the managed lane is free of vehicles, then the price can be reduced to entice more vehicles to enter the lane. However, using rigid calculations of volumes and speeds, the price may adjust too rapidly so as to cause undesirable swings in the amount of cars in the managed lane.

According to principles described herein, price adjustments are made dynamically taking into account rates of change in the level-of-service and using non-linear functions so as to provide more stability in a defined level-of-service. Specifically, a tollway operator is provided with the means to select a customized definition of level-of-service. Various level-of-service definitions may include, for example, average vehicle speed or average distance between vehicles. Using a defined level-of-service type, the tollway operator may set a target level-of-service. A computing system may then determine the current level-of-service (through use of roadway sensors) and detect the difference between the current level-of-service and the target level-of-service. And, the system can determine the rate at which the current level-of-service is increasing or decreasing. Using this information, the computing system can determine a price adjustment (either an increment or a decrement) to produce a desirable outcome and keep that outcome relatively stable.

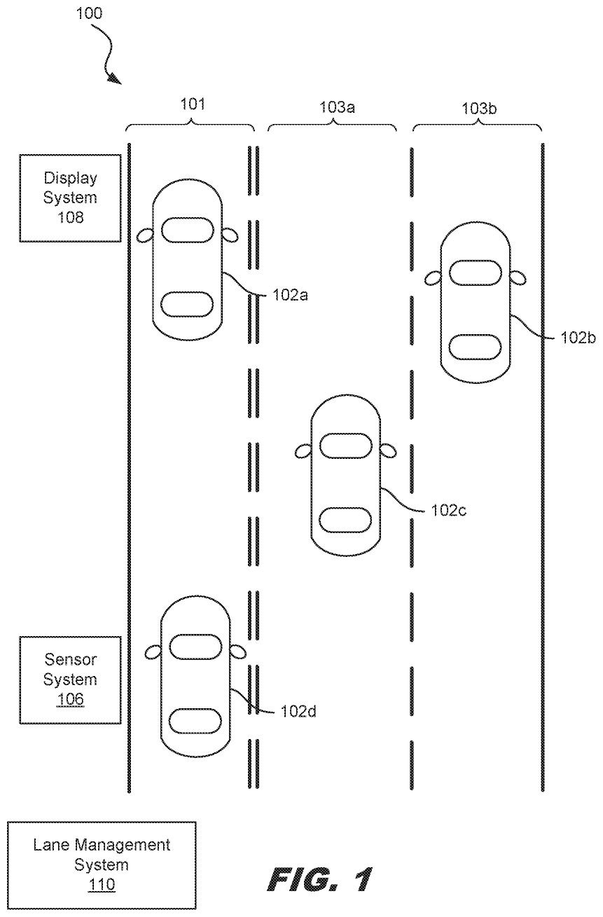

FIG. 1 is a diagram showing an illustrative environment with general-purpose lanes and a managed lane in which non-linear dynamic pricing may be used. According to the present example, the environment 100 includes a managed lane 101 and two general-purpose lanes 103a, 103b. Vehicles 102a and 102d are travelling within the managed lane 101. Vehicle 102c is within general-purpose lane 103a and vehicle 102b is within general purpose-lane 103b.

In general, vehicles may have the option of entering or exiting the managed lane at will at specified points along the roadway (or anyway in the roadway in some environments). Various tolling mechanisms may be used to charge customers for using the managed lane 101. For example, users may have tolling transponders within their vehicles. Alternatively, the tolling system may be able to detect various identifying tokens from the vehicle, such as a license plate. The tolling transponders or license plates may be associated with a customer account that is charged based on the vehicle usage of the managed lane 101.

The price for using the managed lane 101 may be adjusted in real-time based on the conditions within the managed lane. Specifically, the price may be dynamically adjustment based on calculations made by a lane management system 110. The lane management system 110 may be in communication with a sensor system 106 and a display system 108. In some examples, the lane management system 110 may be adjacent to the roadway. However, in some cases, the lane management system may be remotely positioned with respect to the roadway and be in remote communication with the sensor system 106 and the display system 108.

The sensor system 106 includes various sensor devices to detect conditions within the managed lane 101. For example, the sensor system 106 may include cameras, infrared, RADAR, LIDAR, and other sensors used to detect the number of vehicles, speed of the vehicles, and distance between vehicles in a particular lane. This information can then be used to gauge a defined level-of-service, as will be discussed in further detail below.

The display system 108 is a mechanism for displaying the current price at a particular location to use the managed lane 101. The displayed toll may be the cost to traverse a particular section of the managed lane 101 (e.g., 2 miles). Alternatively, the displayed toll may be the cost to pass through a particular toll tunnel. The price may be displayed using a marquee or LED display that can be updated as the price changes. By adjusting the toll for the managed lane 101 in real-time, traffic may be better aligned to meet various goals.

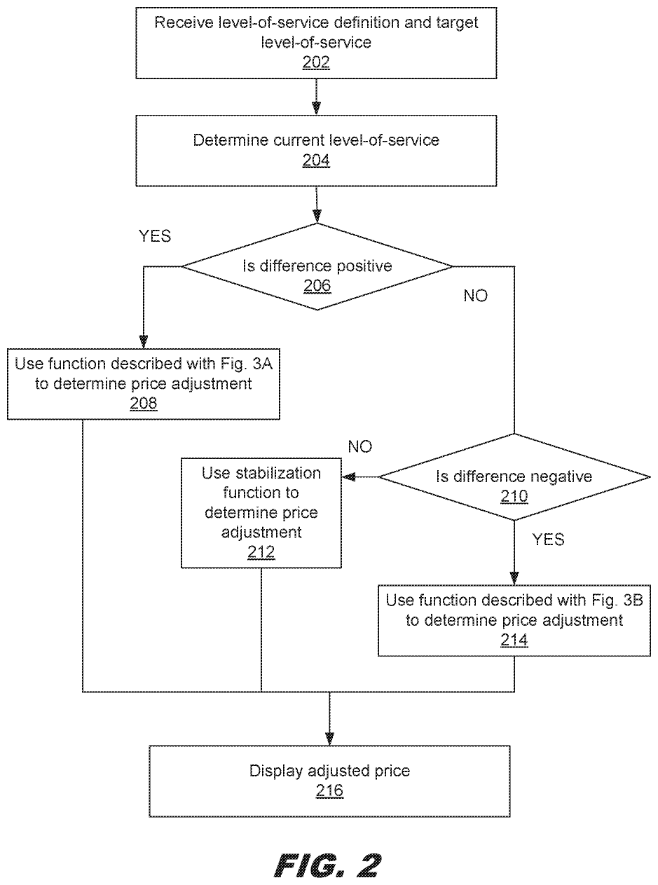

FIG. 2 is a flowchart showing an illustrative method for non-linear dynamic pricing for tolling systems. According to the present example, the method 200 includes a process 202 for receiving a target level-of-service definition. The target level-of-service represents an ideal value for however the level-of-service is defined.

The level-of-service may be defined in a variety of manners. In some examples, it can be defined as a target average speed for vehicles within the managed lane. For example, it may be desirable that the average speed in the managed lane be about 65 miles per hour. The level-of-service may also be defined as a target density (i.e., number of vehicles within a given length). The level-of-service may also be defined as the average distance between vehicles. In some cases, the level-of-service may be defined using average length and average speed, or other combinations of metrics.

The following description of the level-of-service will use various terms, which will be defined below. Following the definitions, the dimension of the quantities is reported in the square parenthesis (L=length, T=Time).

In the following formula the quantities are defined as function of time in the form Quantity^{Lane Type} (t). Lane type can be ML (Managed Lane) or GP (General Purpose Lane). Time may either be defined as continuous or discrete intervals.

Speed is the average value of vehicle speed measured on a segment in a certain interval of time for both Managed Lanes (ML) and General Purpose Lanes (GP).

$${S}^{M L} ( t ) , {S}^{G P} ( t ) \to [ \frac{L}{T} ]$$

Volume is the average number of vehicle transits per lane within a time interval (for example, speed or volume may be averaged on a time interval of three minutes). The quantities are defined per lane. This means that if the ML or GP lanes have more than one lane (as is normal for the GP) the volume must be averaged on the number of lanes. Speed is normally expressed in miles per hour and volume is expressed in vehicles per hour.

$${V}^{M L} ( t ) , {V}^{G P} ( t ) \to [ \frac{1}{T} ]$$

Densities for both ML and GP Lanes are defined as

$${D}^{M L} ( t ) = \frac{{V}^{M L} ( t )}{{S}^{M L} ( t )} , {D}^{G P} ( t ) = \frac{{V}^{G P} ( t )}{{S}^{G P} ( t )} \to [ \frac{1}{T} \cdot \frac{T}{L} ] = [ \frac{1}{L} ]$$

Density represents the average number of vehicles per unit of length. One way to describe the traffic characteristics related to the volume is the average Inter Arrival Time (IAT) as the average time between any two vehicles, and it is defined below:

$${T}^{M L} ( t ) = ( \frac{1}{{V}^{M L} ( t )} ) , {T}^{G P} ( t ) = ( \frac{1}{{V}^{G P} ( t )} ) \to [ T ]$$

The introduction of the IAT provides various benefits. For example, it simplifies the formulas and gives a more intuitive interpretation of the quantities that will be defined further below. Using this definition, density may be defined as:

$${D}^{M L} ( t ) = \frac{1}{{T}^{M L} ( t ) \cdot {S}^{M L} ( t )} , \\ {D}^{G P} ( t ) = \frac{1}{{T}^{G P} ( t ) \cdot {S}^{G P} ( t )} \to [ \frac{1}{T} \cdot \frac{T}{L} ] = [ \frac{1}{L} ]$$

In some examples, the level-of-service can be defined mathematically such that a higher value for the level-of-service is a more desirable condition (e.g., higher average speed) and a lower value for the level-of-service is a less desirable condition. In one example, the level-of-service may be defined as the inverse of density (the higher the density the lower the level-of-service and vice versa). In this example, the level-of-service LoS(t) is the average distance between the vehicles in a determinate instant of time:

$$L o S ( t ) = \frac{1}{D ( L )} \to [ L ]$$

In some examples, a normalized level-of-service may be used. The normalized level-of-service may also be described as the difference between a target level-of-service and a current level-of-service. Using an example in which the level-of-service is the average speed of vehicles in a lane, a target level-of-service may be 65 miles per hour and a current level-of-service may be 50 miles per hour. In this case, the normalized level-of-service is −15 miles per hour. If the current level-of-service matches the target level-of-service, then the normalized level-of-service is zero. Positive values of a normalized level-of-service represent a higher level-of-service and negative values represent an undesirable level-of-service. T⁰ and S⁰ are a reference time and a reference speed that are used to set the reference value for the LoS. The two values are pure numbers. They represent the positive or negative percentages of deviation from the optimum values for S and T defined by S⁰ and T⁰.

The target density may be defined as follows:

$${D}^{0} = \frac{1}{{T}^{0} \cdot {S}^{0}} \to [ \frac{1}{L} ]$$

This represents the target density if the normalized level-of-service definition is

$$( t ) = \frac{{D}^{0} - D ( t )}{{D}^{0}} = \frac{T \cdot S - {T}^{0} \cdot {S}^{0}}{T \cdot S}$$

This definition sets the normalized level-of-service to zero when the current density equals the reference density D⁰. If the current density is smaller than the reference density, the level-of-service is positive (better services than the standard). If the current density is greater than the reference density the level-of-service is negative (worst service level than the standard).

In some examples, the level-of-service can be defined as follows:

$$( t ) = 2 \cdot \frac{T ( t ) \cdot S ( t )}{{T}^{0} {S}^{0}} - ( \frac{T ( t ) \cdot {S}^{0}}{{T}^{0} \cdot S ( t )} + \frac{{T}^{0} \cdot S ( t )}{T ( t ) \cdot {S}^{0}} )$$

In some examples, the level-of-service may be defined relative to the general-purpose lane. Using speed alone as an example level-of-service, a target level-of-service may be for the managed lane to be 25 miles per-hour-faster than the general purpose lanes (subject to maximum constraints). For example, the level-of-service may be defined as follows:

[symbol]

(t)=λ· [symbol] ^{ML}(t)−(1−λ)·(ΔLoS(t)−ΔLoS⁰)

Where 0≤λ≤1 defines the relative weight between considering the absolute value of the level-of-service on the managed lane and the differential of the level-of-service between managed lanes and general purpose lanes. In this example, ΔLoS⁰ may be a customer (tollway operator) defined parameter that defines the “desired” difference in level-of-service between managed lanes and general purpose lanes. Note that ΔLoS⁰ acts only on the second component of the [symbol] (t) calculation. This means that the impact of the term ΔLoS (t)−ΔLoS⁰ is mitigated by values of λ>0.

ΔLoS(t)= [symbol] ^{ML}(t)− [symbol] ^{GP}(t)

If λ=1 the level-of-service is calculated independently from what is happening on the general purpose lanes. Lower values of λ augment the impact of the contribution of the term ΔLoS (t)−ΔLoS⁰ that take in account the difference in level-of-service between managed lanes and general purpose lanes. In other words, if the goal is to only manage traffic with respect to the managed lane telemetry, the value of λ can be set to 1. Consequently, the level-of-service will be calculated only with managed lane parameters.

This doesn't necessarily mean that what happens on the general-purpose lane does not influence the dynamically controlled toll price. The decision to use the managed lane by the vehicle driver can be based on, for example, the visible or communicated (sign, traffic news, mobile app services, etc.) conditions on the general-purpose lanes. The price, in other words, in case of congestion on the general-purpose lanes, will rise to keep the level-of-service stable on the managed lanes because more drivers will be encouraged to use the managed lane instead of the general-purpose lanes.

The method 200 further includes a process 204 for determining the current level-of-service, as it is defined. For example, if the level-of-service is density, then the current density in the managed lane may be measured using the sensor system 108. Using this information gathered from the sensor system, the difference between the target level-of-service and the current level-of-service may be calculated. This difference may also be referred to as the normalized level-of-service.

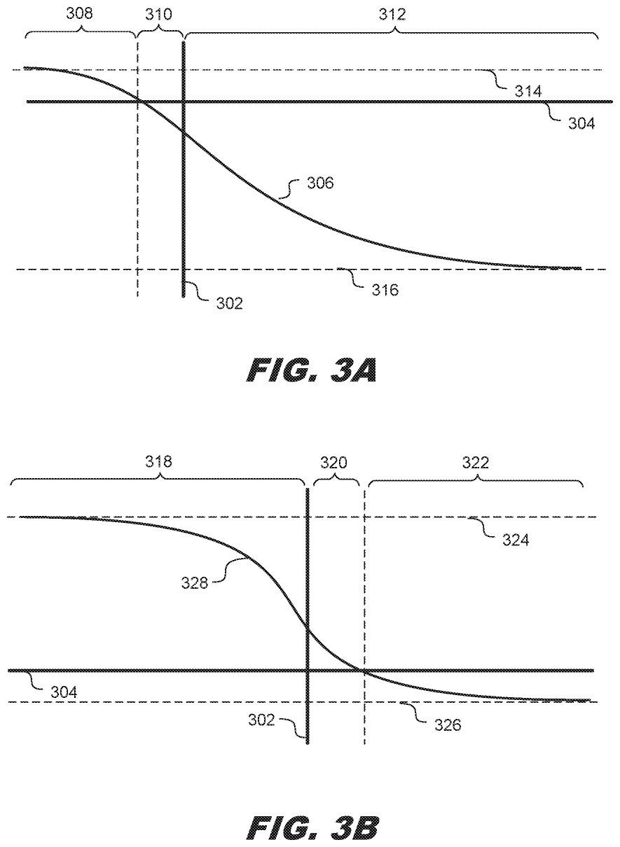

The method 200 further includes a process 206 for determining whether the normalized level-of-service is positive. If so, then the method proceeds to process 208. At process 208, the method calculates a price adjustment based on a first non-linear function, as illustrated in FIG. 3A.

FIG. 3A is a diagram showing an illustrative graph showing a non-linear relationship between price adjustment and rate-of-change for a positive level-of-service differential (i.e., a normalized level-of-service). In other words, at all points in the graph, the normalized level-of-service is positive, meaning that the current level-of-service is better than the ideal level-of-service. Generally in this scenario, it is desirable to decrease the price to encourage more people to enter the managed lane. However, as will be explained below, there are scenarios in which price is actual incremented in order to reduce undesirable oscillation.

The x-axis 302 represents a price adjustment. In other words, parts of the graph above the y-axis 304 represent a price increment and parts of the graph below the y-axis represent a price decrement. The y-axis 304 represents a rate-of-change of the normalized level-of-service. In other words, parts of the graph to the right of the x-axis indicate that the current level-of-service minus the target level-of-service is increasing. Conversely, parts of the graph to the left of the x-axis indicate that the current level-of-service minus the target level-of-service is decreasing. FIG. 3A illustrates the price function 306 as a sigmoid function with a maximum value 314 and a minimum value 316. In other words, the price increment will max out at the maximum value 314 and the price decrement will bottom out at the minimum value 316.

In section 312, the normalized level-of-service is increasing relatively quickly. This means that the level-of-service above ideal is rapidly increasing and thus it would be desirable to decrease price. This will encourage more people to use the managed lane. The faster the level-of-service is increasing, the greater the price decrement, per the sigmoid function 306. The price decrement will be constrained by the minimum value. This will prevent a rapid price drop. This minimum value 316 thus regulates the amount of “pressure” that can be deployed to increase the volume in the managed lane because an excessive drop in the price can induce a fast rise on the volume, pushing the normalized level-of-service values strongly negative. This in turn would cause a rapid price increase, leading to undesirable stabilization.

In section 310, the normalized level-of-service is positive and slowly decreasing. In this case, there is a relatively small price decrement to more moderately encourage drivers to enter the managed lane. In section 308, the normalized level-of-service is positive and rapidly decreasing. In this case, the price is incremented to discourage people from entering the managed lane. Thus, even though the current level-of-service is better than the target level, that situation is changing rapidly and thus to avoid wild oscillations, the price is incremented to slow down the rapidly decreasing normalized level-of-service.

Returning to FIG. 2, if the normalized level-of-service is not positive, the method 200 proceeds to process 210. At process 310, it is determined whether the normalized level-of-service is negative. If not (neither negative or positive), then the normalized level-of-service is approximately zero and the method proceeds to process 212. At process 212, a stabilization function may be used to keep the level-of-service near zero. This may involve small price increments and decrements depending on various conditions.

If, however, the normalized level-of-service is negative, the method 200 proceeds to process 214. At process 214, the price adjustment is determined based on a non-linear relationship between price and rate of change as shown in FIG. 3B.

FIG. 3B is a diagram showing an illustrative graph showing a non-linear relationship between price adjustment and rate-of-change for a negative level-of-service differential (i.e., a normalized level-of-service). In other words, at all points in graph, the normalized level-of-service is negative, meaning that the current level-of-service is worse than the ideal level-of-service. Generally, in this scenario, it is desirable to increase the price to encourage more people to leave the managed lane. However, as will be explained below, there are scenarios in which price is actual decremented in order to reduce undesirable oscillation.

The x-axis 302 represents a price adjustment. In other words, parts of the graph above the y-axis 304 represent a price increment and parts of the graph below the y-axis represent a price decrement. The y-axis 304 represents a rate-of-change of the normalized level-of-service. In other words, parts of the graph to the right of the x-axis indicate that the current level-of-service minus the target level-of-service is increasing. Conversely, parts of the graph to the left of the x-axis indicate that the current level-of-service minus the target level-of-service is decreasing. FIG. 3B illustrates the price function 328 as a sigmoid function with a maximum value 324 and a minimum value 326. In other words, the price increment will max out at the maximum value 324 and the price decrement will bottom out at the minimum value 326.

In section 318, the normalized level-of-service is decreasing relatively quickly. This means that the level-of-service below ideal is rapidly decreasing (getting worse) and thus it would be desirable to increase price. This will encourage more people to leave the managed lane or avoid entering the managed lane. The faster the level-of-service is decreasing, the greater the price increment, per the sigmoid function 328. The price increment will be constrained by the maximum value 324. This will prevent a rapid price increase, which in turn would cause rapidly decreasing level-of-service, which could lead to wild oscillations.

In section 320, the normalized level-of-service is negative and slowly increasing. In this case, there is a relatively small price increment to more moderately encourage drivers to leave the managed lane. In section 322, the normalized level-of-service is negative and rapidly increasing. In this case, the price is actually decremented to encourage people to enter the managed lane. Thus, even though the current level-of-service is worse than the target level, that situation is changing rapidly and thus to avoid wild oscillations, the price is decremented to slow down the rapidly increasing normalized level-of-service.

In any case, after the price increment is determined, it is then displayed accordingly at process 216. In some examples, the frequency at which the price is adjusted may be constrained. For example, it may be the case that price is adjusted at intervals of 5 minutes. Other time intervals are contemplated.

The price adjustment may be defined as a summing positive or negative increment to the previous established price:

p(t)=p(t−δt)+Δp(t),t=n·δt,n∈ [symbol] ⁺

δt is the interval of time between two price calculations, and n is the discrete time index (it represents the counter of the sequence of instant of duration δt in correspondence of which the new price is calculated). The δt value can be different from the traffic measurement aggregation. For example, δt can be set to 5 minutes. The Traffic measurement can be done on a mobile average window of the same magnitude or the aggregation on a smaller window (for example 30 seconds). The aggregation criteria impact on the variability of the price. In fact, a larger aggregation interval leads to a smoother variation of the measurements.

The pricing algorithm may be defined as a function of the level-of-service and of its time first derivative with respect to time (in other words, the rate of change):

$$Δ p ( t ) = δ p \cdot f ( ( t ) , \frac{\partial ( t )}{\partial t} ) , f ( … ) \to ℕ$$

δp is the minimum admissible variation of process and the function ƒ( ) gives back positive and negative integers. The price does not vary freely because it would be forced to remain in a configurable band of oscillation depending on level-of-service or density values. The value of δp is important because it defines (together with the shape of function) the speed the price can rise or drop in response to a variation in the level-of-service.

The f( ) function is the multiplier of the minimum price increment δp. In the following definition a standard continuous definition of a sigmoid called “Logistic Function” may be used. In the computing implementation the curve can be approximated by connected line or polynomial functions.

$$f ( ( t ) , \frac{\partial ( t )}{\partial t} ) = \{ \begin{matrix}if ( t ) > 0 & f = - ⌊ \frac{{L}^{+}}{1 + {e}^{- {k}^{+} ( \frac{\partial ( t )}{\partial t} - {l}^{+} )}} + {C}^{+} ⌋ \\ if = 0 & f = ρ ( t ) \\ if ( t ) < 0 & f = ⌊ \frac{{L}^{-}}{1 + {e}^{- {k}^{-} ( - \frac{\partial ( t )}{\partial t} {l}^{-} )}} - {C}^{-} ⌋\end{matrix}$$

k⁺ regulates the slope of the flex point of the curve. l⁺ is the value of the sigmoid mid value (positive value shift the curve on the right, negative to the left of the vertical axis). L⁺ defines the vertical span of the curve between the two horizontal asymptotes. C⁺ defines the quantity of vertical shift of the curve above the horizontal axis for positive values, (otherwise the sigmoid will remain negative for all values with the horizontal axis as upper asymptote). ρ(t) describes the behavior of the function when the [symbol] (t) is steady at 0. In this case there are three possible approaches. The need to introduce some change to a steady situation came from the possibility that even though the normalized LoS is in at 0, a higher pricing or a higher volume can make the system move in more desirable equilibrium. ρ(t)=0, which implies that the price remains constant. ρ(t)=−1, the price is decremented to push more volume in the managed lane. ρ(t)=+1 the price is increased, this can lead to the same level-of-service but with higher revenues but can tend to maintain the volume or decrease it. ρ(t)=random−1, +1, to prevent the system from remaining in a local optimization without a predefined direction. Note that to simplify calculations and Land C⁺ should be defined as positive integers with L⁺>C⁺.

The functions are sigmoid (logistic function) with inverted sign depending on the sign of the [symbol] (t). The use of the sigmoid function avoids the increments being directly proportional to the level-of-service variation. Abrupt variation on pricing can lead to undesired instability on the feedback chain between price variation and human reaction. The sigmoid introduces a non-linear saturation of the maximum price variation that acts as a “shock absorber” avoiding uncontrolled and chaotic system behaviors.

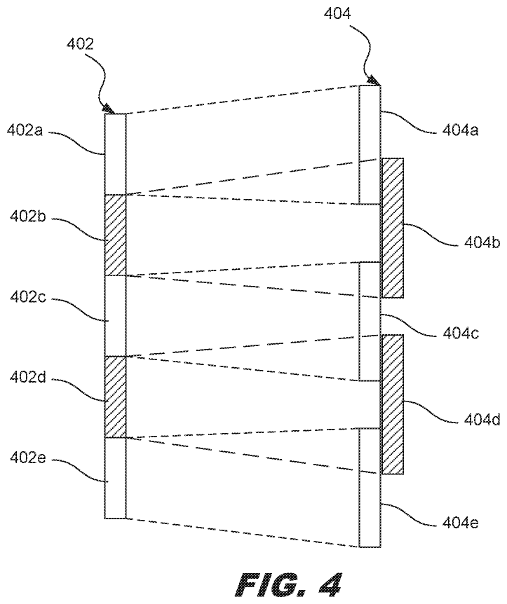

FIG. 4 is a diagram showing illustrative level-of-service bands 402. According to the present example, different bands 402 within the level-of-service spectrum may be defined. For example, in the case where the level-of-service is defined by speed alone, it may be that there is a defined band between 0 and 15 miles per hour of the normalized level-of-service. There may also be another band at 15-30 miles per hour. There may also be negative bands such as −15 to zero miles per hour. Each separate band may have a different price band 404. The price bands may overlap, as shown in FIG. 4.

FIG. 4 illustrates four different level-of-service bands 402a, 402b, 402c, 402d, 402e. Associated with each level-of service band is a price band 404a, 404b, 404c, 404d, 404e. The price bands overlap such that, for example, the minimum price for band 402a is less than the maximum price for band 402b. Similarly, the minimum price for band 402b is less than the maximum price for band 402c. The price bands 404 may correspond to minimum and maximum values in the sigmoid functions described above.

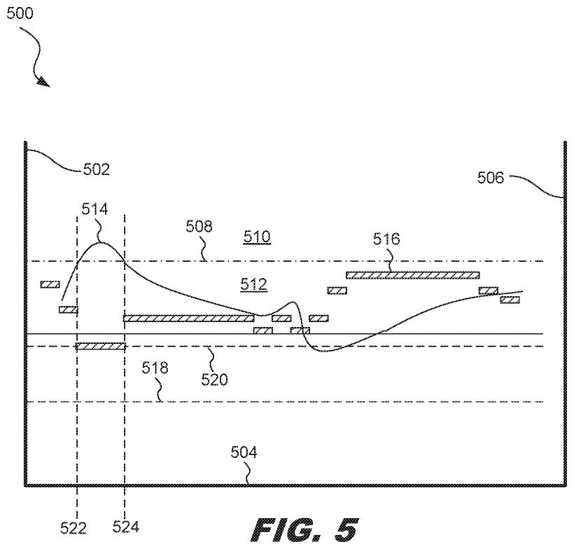

FIG. 5 is a diagram showing price over time with various level-of-service bands. According to the present example, the left vertical axis 502 represents level-of-service (either absolute or normalized). The right vertical axis 506 represents price. The horizontal axis represents time. As can be seen, the level-of-service 514 varies with time. The level-of-service may be within one of two bands 510, 512 separated by line 508. It is noted that while the present example illustrates two bands, other embodiments in which there are other bands may be utilized.

As the level-of-service changes, the price 516 also changes according to the techniques described above. As can be seen, the price 516 jumps at quantized increments based on the changing level-of-service and the functions described above. When, at point 522, the level-of-service passes from band 512 to band 510, the price 516 becomes subject to the constraints of band 510. In the present example, the price for band 510 is constrained by a minimum 518 and a maximum 520. Thus, the price 516 drops down to the maximum level for band 510. However, once the level-of-service 514 drops back into band 512 at point 524, the price is no longer subject to the constraints of band 510. Thus, the price 516 jumps to a higher level.

Using level-of-service bands and price bands as described above provides various advantages. For example, toll operators are provided with more customizations. This higher level of customization may make it easier or possible for the toll operator to comply with various contractual or regulatory obligations.

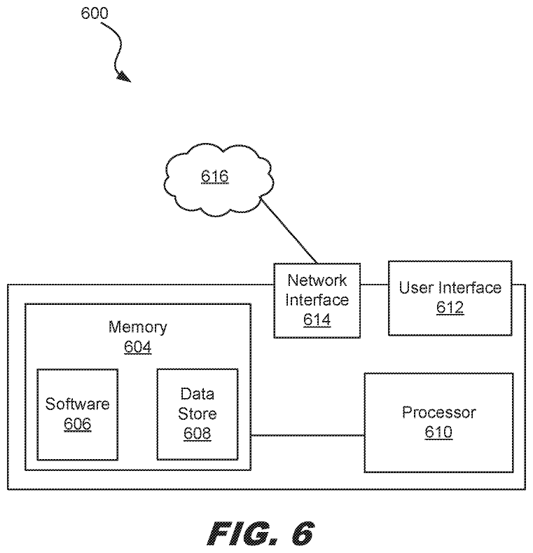

FIG. 6 is a diagram showing an illustrative computing system that may be used for managing non-linear dynamic pricing. For example, the computing system 600 may be used to perform the functions associated with the lane management system 110. Other functions described herein may also be performed by computing systems such as computing system 600. According to certain illustrative examples, the computing system 600 includes a memory 604 which may include software 606 and a data store 608. The processing system 600 also includes a processor 510, a network interface 614, and a user interface 612.

The memory 604 may be one of several different types of memory. Some types of memory, such as solid-state drives, are designed for storage. These types of memory typically have large storage volume but relatively slow performance. Other types of memory, such as those used for Random Access Memory (RAM), are optimized for speed and are often referred to as “working memory.” The various types of memory may store information in the form of software 606 and data in the data store 608.

The computing system 600 also includes a processor 610 for executing the software 606 and using or updating the data 508 stored in memory 604. The software 606 may include an operating system and any other software applications a user may wish to install. In some examples, the computing system 600 may be associated with a user. In such case, the software 606 may be an application to render web content, such as a browser. The software 606 may include machine readable instructions of a computer program product that when executed, perform the functions described above.

The user interface 612 may include a number of input devices such as a mouse, touchpad, or touchscreen that allow the user to interact with the computing system 600. The user interface 612 may also include a number of different types of output devices such as a monitor or a touchscreen. The user interface allows the user to interact with the processing system 600 in a manner as described above.

The network interface 614 may include hardware and software that allows the processing system 600 to communicate with other processing systems over a network 616. The network interface 614 may be designed to communicate with the network 616 through hardwire media such as Ethernet, coaxial, fiber-optic, etc. The network interface 614 may also be designed to communicate with the network 616 using wireless technologies.

Some examples of processing systems described herein may include non-transitory, tangible, machine readable media that include executable code that when run by one or more processors may cause the one or more processors to perform the processes of methods as described above. Some common forms of machine-readable media that may include the processes of methods are, for example, floppy disk, flexible disk, hard disk, magnetic tape, any other magnetic medium, CD-ROM, any other optical medium, RAM, PROM, EPROM, FLASH-EPROM, any other memory chip or cartridge, and/or any other medium from which a processor or computer is adapted to read.

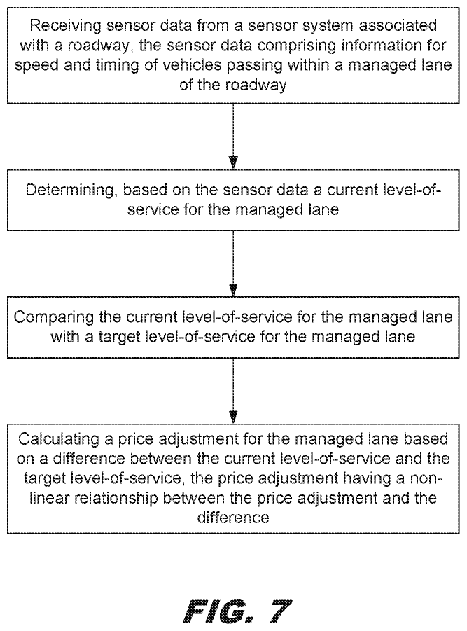

FIG. 7 is a flowchart showing an illustrative method for non-linear dynamic pricing for tolling systems. According to the present example, the method 700 includes a process 702 for receiving sensor data from a sensor system associated with a roadway, the sensor data comprising information for speed and timing of vehicles passing within a managed lane of the roadway. The method 700 further includes a process 704 for determining, based on the sensor data a current level-of-service for the managed lane. The method 706 further includes a process 706 for comparing the current level-of-service for the managed lane with a target level-of-service for the managed lane. The method 700 further includes a process 708 for calculating a price adjustment for the managed lane based on a difference between the current level-of-service and the target level-of-service, the price adjustment having a non-linear relationship between the price adjustment and the difference.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method comprising:
receiving sensor data from a sensor system associated with a roadway, the sensor data comprising information for speed and timing of vehicles passing within a managed lane of the roadway;
determining, based on the sensor data a current level-of-service for the managed lane;
comparing the current level-of-service for the managed lane with a target level-of-service for the managed lane;
calculating a price adjustment for the managed lane based on a difference between the current level-of-service and the target level-of-service, the price adjustment having a non-linear relationship between the price adjustment and the difference.

2. The method of claim 1, wherein the target level-of-service comprising a target average vehicle speed.

3. The method of claim 1, wherein the target level-of-service comprises a target average distance between vehicles.

4. The method of claim 1, wherein the target level-of-service comprises a target average amount of time in which successive vehicles pass by a fixed point.

5. The method of claim 1, wherein the target level-of-service comprises a target volume of vehicles for the managed lane.

6. The method of claim 1, wherein target level-of-service is defined relative to a general-purpose lane.

7. The method of claim 1, wherein the target level-of-service is an absolute value.

8. The method of claim 1, wherein the sensor system includes at least one of: cameras, infrared, RADAR, or LIDAR.

9. The method of claim 1, wherein a level-of-service is normalized such that the difference between the current level-of-service and the target level-of-service is zero.

10. The method of claim 1, wherein calculating the price adjustment factors in a rate of change of the difference.

11. The method of claim 10, wherein calculating the price adjustment uses a function such that when the difference is positive and the current level-of-service is increasing, price is decremented at various amounts as a function of rate of increase for the current level-of-service.

12. The method of claim 10, wherein calculating the price adjustment uses a function such that when the difference is positive and the current level-of-service is decreasing by more than a threshold amount, price is incremented at various amounts as a function of rate of decrease for the current level-of-service.

13. The method of claim 10, wherein calculating the price adjustment uses a function such that when the difference is negative and the current level-of-service is increasing greater than a threshold amount, price is decremented at various amounts as a function of rate of increase for the current level-of-service.

14. The method of claim 10, wherein calculating the price adjustment uses a function such that when the difference is negative and the current level-of-service is decreasing, price is incremented at various amounts as a function of rate of decrease for the current level-of-service.

15. A method performed by a computing system, the method comprising:
determining a target level-of-service for a managed lane;
with a sensor system, determining a current level-of-service for the managed lane;
displaying a first price for the managed lane;
displaying an adjusted price for the managed lane, the adjusted price being a quantized value and being determined based on a non-linear relationship between price difference and a difference between the current level-of-service and the target level-of-service.

16. The method of claim 15, wherein the non-linear relationship is defined by a sigmoid function.

17. The method of claim 15, wherein the level-of-service is defined by at least one of: a target average vehicle speed, a target average distance between vehicles, a target average amount of time in which successive vehicles pass by a fixed point, and a target volume of vehicles.

18. A system comprising:
a processor; and
a memory comprising machine-readable instructions that when executed by the processor, cause the system to:
receive sensor data from a sensor system associated with a roadway, the sensor data comprising information for speed and timing of vehicles passing within a managed lane of the roadway;
determine, based on the sensor data a current level-of-service for the managed lane;
compare the current level-of-service for the managed lane with a target level-of-service for the managed lane;
calculate a price adjustment for the managed lane based on a difference between the current level-of-service and the target level-of-service, the price adjustment having a non-linear relationship between the price adjustment and the difference.

19. The system of claim 18, wherein the target level-of-service is defined relative to a general-purpose lane.

20. The system of claim 18, wherein the sensor system includes at least one of: cameras, infrared, RADAR, or LIDAR.
